(19) United States
(12) Patent Application Publication
(10) Pub. No.: US 2019/0068813 A1
(43) Pub. Date: Feb. 28, 2019

(54) SHEET CONVEYING DEVICE AND IMAGE READING DEVICE

(71) Applicant: TOSHIBA TEC KABUSHIKI KAISHA, Tokyo (JP)

(72) Inventor: Takeshi ITO, Mishima Shizuoka (JP)

(21) Appl. No.: 16/027,760

(22) Filed: Jul. 5, 2018

(30) Foreign Application Priority Data
Aug. 31, 2017 (JP) 2017-167676

(51) Int. Cl. H04N 1/00; G01B 11/04

(52) U.S. Cl. CPC H04N 1/00713; H04N 1/00655; G01B 11/043

(57) ABSTRACT

A sheet conveying device includes a length sensor configured to detect a length of a sheet to be conveyed, and a processor configured to determine the length of the sheet while operating in a first mode and while operating in a second mode. While operating in the first mode, the processor determines the length detected by the length sensor as the length of the sheet. While operating in the second mode, the processor determines a predefined length as the length of the sheet, wherein the predefined length is greater than a shortest length detectable by the length sensor.

### CROSS-REFERENCE TO RELATED APPLICATION

This application is based upon and claims the benefit of priority from Japanese Patent Application No. 2017-167676, filed Aug. 31, 2017, the entire contents of which are incorporated herein by reference.

### FIELD

An embodiment described herein relates generally to a sheet conveying device and an image reading device.

### BACKGROUND

In the related art, a sheet conveying device configured to detect a sheet length in a conveying direction based on detection signal from a sensor provided on a tray, is known. However, there is a case where the sensor cannot correctly detect the sheet length. For example, when a non-regular-sized original document is placed on the tray, or when conveying the document is partially spaced apart from the tray due to a fold thereof, a sheet length may not be correctly detected. In such a case, a read image would be clipped due to erroneous detection of a sheet length.

### DESCRIPTION OF THE DRAWINGS

FIG. 1 is an external view of a sheet conveying device of an embodiment.

FIG. 2 is a functional block diagram of the sheet conveying device of the embodiment.

FIG. 3 is a flowchart of processing performed by a processor of the sheet conveying device.

FIG. 4 is a flowchart of determining when a sheet width is the length of a short side of a legal size.

FIG. 5 is an external view of an image forming device to which the sheet conveying device of the present embodiment is applied.

FIG. 6 is a functional block diagram of an image reading device.

### DETAILED DESCRIPTION

Embodiments provide a sheet conveying device and an image reading device capable of reducing erroneous detection of a sheet length.

In general, according to one embodiment, the sheet conveying device includes a length sensor configured to detect a length of a sheet to be conveyed, and a processor configured to determine the length of the sheet while operating in a first mode and while operating in a second mode. While operating in the first mode, the processor determines the length detected by the length sensor as the length of the sheet. While operating in the second mode, the processor determines a predefined length as the length of the sheet, wherein the predefined length is greater than a shortest length detectable by the length sensor.

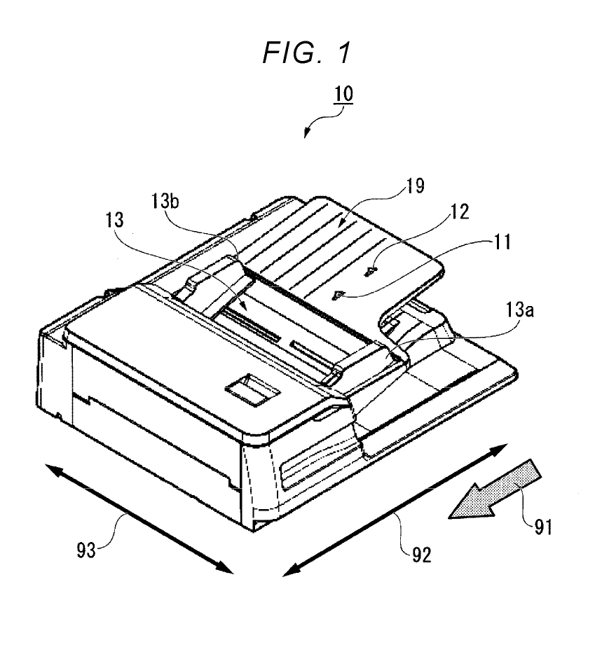

Hereinafter, a sheet conveying device of an embodiment will be described with reference to drawings. FIG. 1 is an external view of a sheet conveying device 10 of an embodiment. The sheet conveying device 10 includes a tray 19. The sheet conveying device 10 conveys a sheet placed on the tray 19 to a sheet conveying direction indicated by an arrow 91. The sheet is, for example, paper or label paper. The tray 19 includes a first length sensor 11, a second length sensor 12, and a width sensor 13. The first length sensor 11 and the second length sensor 12 detect the length of the sheet placed on the tray 19 in the length direction indicated by an arrow 92. The sheet length indicates the length from one end to the other end in the length direction of the sheet. The width sensor 13 detects the sheet width in a width direction indicated by an arrow 93 with respect to the sheet placed on the tray 19. The sheet width indicates the size from one end to the other end in the width direction of the sheet.

The first length sensor 11 and the second length sensor 12 may be any sensor as long as those sensors can detect the sheet length of the sheet. In the example of FIG. 1, both the first length sensor 11 and the second length sensor 12 include levers elastically biased upward so that a portion of the lever protrudes from a receiving surface of the tray 19. When the sheet is not placed, each of the levers protrudes from the sheet placing surface of the tray 19. When a sheet is placed, the sheet pushes the lever downward by its own weight. This force moves the lever downward against the biasing force. The movement of the lever is detected by a sensor such as an optical sensor, and the presence of the sheet is detected. When the presence of the sheet is detected, it is determined that the sheet length has the length from the edge of the sheet in the sheet placing surface of the tray 19 to the position where at least the presence of the sheet is detected.

The width sensor 13 may be any sensor as long as the width sensor 13 can detect the width of the sheet. In the example of FIG. 1, the width sensor 13 includes a movable wall 13a and a movable wall 13b movable in the width direction. The positions of the movable wall 13a and the movable wall 13b are detected by a sensor such as an optical sensor. The length in the width direction between the movable wall 13a and the movable wall 13b is detected as a sheet width. Either one of the movable wall 13a or the movable wall 13b may be a stationary wall that does not move.

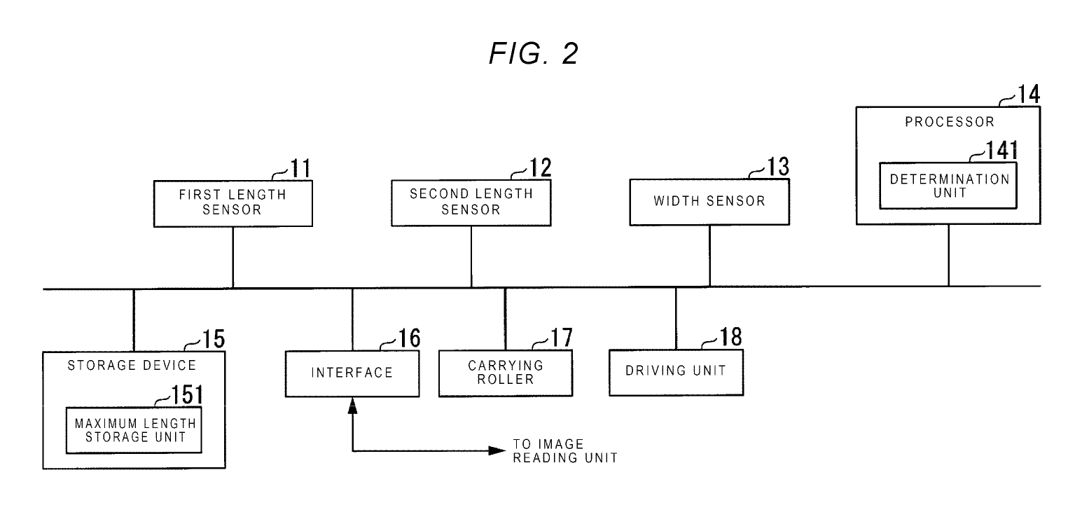

FIG. 2 is a functional block diagram of the sheet conveying device 10 of the embodiment. The sheet conveying device 10 includes the first length sensor 11, the second length sensor 12, the width sensor 13, a processor 14, a storage device 15, an interface 16, a conveying roller 17, and a driving unit 18.

The first length sensor 11 outputs a signal indicating whether or not a sheet is detected at the position where the first length sensor 11 is provided. When a sheet is detected, the first length sensor 11 outputs a signal indicating ON. When no sheet is detected, the first length sensor 11 does not output a signal, or outputs a signal indicating OFF.

The second length sensor 12 outputs a signal indicating whether or not a sheet is detected at the position where the second length sensor 12 is provided. When a sheet is detected, the second length sensor 12 outputs a signal indicating ON. When no sheet is detected, the second length sensor 12 does not output a signal, or outputs a signal indicating OFF.

The width sensor 13 outputs a signal indicating the detected sheet width. The processor 14 is a computing device such as a central processing unit (CPU). The processor 14 functions as a determination unit 141 by executing a predetermined program. The determination unit 141 determines the sheet length of the sheet on the sheet placing surface of the tray 19. The determining process of the determination unit 141 will be described below.

The determination unit 141 acquires mode information set by a user via the interface 16. The mode information indicates an operation mode of the sheet conveying device 10. The operation mode of the sheet conveying device 10 includes a first mode and a second mode. In the first mode, the determination unit 141 determines the length detected based on the outputs of the first length sensor 11 and the second length sensor 12 as a sheet length. In the second mode, the determination unit 141 determines a predetermined length as a sheet length regardless of the outputs of the first length sensor 11 and the second length sensor 12. The predetermined length is longer than the shortest length detectable by the first length sensor 11 and the second length sensor 12. The predetermined length may be, for example, a longest sheet length that may be conveyed by the sheet conveying device 10. The predetermined length may be, for example, the longest sheet length determined according to the sheet width detected by the width sensor 13.

Specific examples of the first mode and the second mode will be described. The sheet conveying device 10 according to the present embodiment has a non-mixed placing mode and a mixed placing mode as specific examples of the first mode and the second mode, respectively. The non-mixed placing mode is a mode selected by the user when a plurality of substantially uniformly-sized sheets are placed on the tray 19 as sheets to be conveyed. In the non-mixed placing mode, since the sheets are substantially uniform, erroneous detection of a sheet length is unlikely to occur. Therefore, in the non-mixed placing mode, an operation is performed with a higher priority given to the speed of the processing, for example image reading, after conveying. The mixed placing mode is a mode selected by the user when a plurality of sheets having different sizes are placed on the tray as sheets to be conveyed. In the mixed placing mode, erroneous detection of a sheet length is likely to occur because the sizes of the placed sheets are different. Therefore, in the mixed placing mode, an operation is performed with a higher priority given to reducing the erroneous detection of a sheet length without prioritizing the speed of the processing after conveying, for example, image reading.

The storage device 15 includes, for example, a magnetic hard disk device or a semiconductor storage device. The storage device 15 functions as a maximum length storage unit 151. The maximum length storage unit 151 stores the sheet width and the corresponding longest sheet length (hereinafter, referred to as “maximum length”) determined according to the sheet width. For example, among the plurality of sheet types having a certain sheet width, the sheet length of the sheet type having the longest sheet length is stored as the maximum length in association with the sheet width. The determination unit 141 may determine the maximum length stored in association with the sheet width detected by the width sensor 13 among the plurality of sheet widths stored in the maximum length storage unit 151 as a sheet length.

The interface 16 transmits and receives signals between the sheet conveying device 10 and other devices. The interface 16 may transmit and receive signals to and from an image reading device to which the sheet conveying device 10 is connected, for example. For example, the interface 16 may receive a signal indicating mode information entered by the user to the image reading device. For example, the interface 16 may transmit a signal indicating the sheet length determined by the determination unit 141 to the image reading device.

The conveying roller 17 is provided in a part of the conveying path of the sheet conveying device 10. The conveying roller 17 moves the sheet to be conveyed in the conveying direction along the conveying path by rotating. conveying The sheet conveying device 10 may have one or more conveying rollers 17.

The driving unit 18 drives the conveying roller 17. The driving unit 18 is, for example, a motor. The driving unit 18 may be operated in accordance with control by the processor 14.

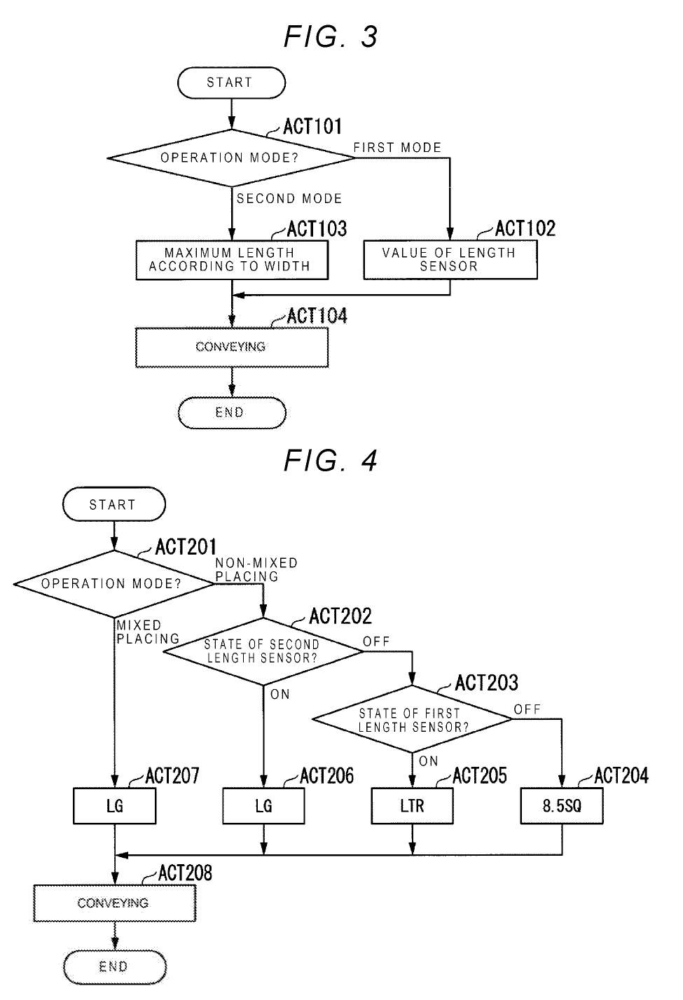

FIG. 3 is a flowchart of processing performed by the processor 14 of the sheet conveying device 10. When conveying the sheet, the determination unit 141 of the processor 14 first determines an operation mode (ACT 101). When the operation mode is the first mode (ACT 101—first mode), the determination unit 141 acquires the output of the first length sensor 11 and the second length sensor 12. Then, the determination unit 141 determines a sheet length based on the output of the length sensor (ACT 102).

On the other hand, when the operation mode is the second mode (ACT 101—second mode), the determination unit 141 determines the maximum length according to the detection result of the sheet width indicated by the width sensor 13 as a sheet length, regardless of the output of the first length sensor 11 and the second length sensor 12 (ACT 103). When the sheet length is determined in the ACT 102 or the ACT 103, the processor 14 executes the conveying according to the sheet length as the determination result (ACT 104).

FIG. 4 is a flowchart of determining when the sheet width is legal size (hereinafter, abbreviated as “LG”) short side length (216 mm) in the determining performed by the determination unit 141 of the processor 14 of the sheet conveying device 10. When conveying the sheet, the determination unit 141 of the processor 14 first determines an operation mode (ACT 201). When the operation mode is the non-mixed placing mode (ACT 201—non-mixed placing mode), the determination unit 141 acquires the output of the second length sensor 12 and the output of the first length sensor 11.

When the outputs of the first length sensor 11 and the second length sensor 12 are off (ACT 203—OFF), the determination unit 141 determines that a sheet length is the long side of 8.5 SQ (ACT 204). 8.5 SQ indicates a square sheet with a side length of 216 mm. On the other hand, when the output of the first length sensor 11 is ON (ACT 203—ON), the determination unit 141 determines that a sheet length is a length of the long side of a letter size (hereinafter, abbreviated as “LTR”) (ACT 205). In the ACT 202, when the output of the second length sensor 12 is on (ACT 202—on), the determination unit 141 determines a sheet length is a length of the long side of LG (ACT 206).

When the operation mode is mixed placing mode (ACT 201—mixed placing mode), the determination unit 141 reads the maximum length when the sheet width is the short side length of LG from the maximum length storage unit 151. Then, the determination unit 141 determines the read maximum length to be a sheet length (ACT 207). The maximum length when the sheet width is the length of the short side of LG may be, for example, the length of the long side of LG. When a sheet length is determined in any one of ACT 204 to 207, the processor 14 executes the conveying according to the sheet length as the determination result (ACT 208).

With the sheet conveying device 10 described above, in the case of the first mode, a sheet length is determined in accordance with the detection result of the first length sensor 11 and the second length sensor 12. In this case, a sheet length is determined with higher accuracy. On the other hand, in the second mode, a sheet length is determined as a predetermined length regardless of the detection result of the length sensor. In this case, even if the length sensor erroneously detects a sheet length, the sheet length is determined as a predetermined length. Therefore, in the subsequent processing, (for example, image reading), processing may be performed with the sheet length closer to or equal to an actual length. For example, when the maximum length is used as the predetermined length, it is possible to prevent the occurrence of clipping of the image read by the image reading device. On the other hand, in the case of the first mode, since a sheet length is detected according to the detection result of the length sensor, it is possible to detect the precise sheet sizes. As a result, it is possible to prevent the time required for the image reading from becoming long since, in the first mode, an operation is performed with a higher priority given to the speed of the processing after conveying.

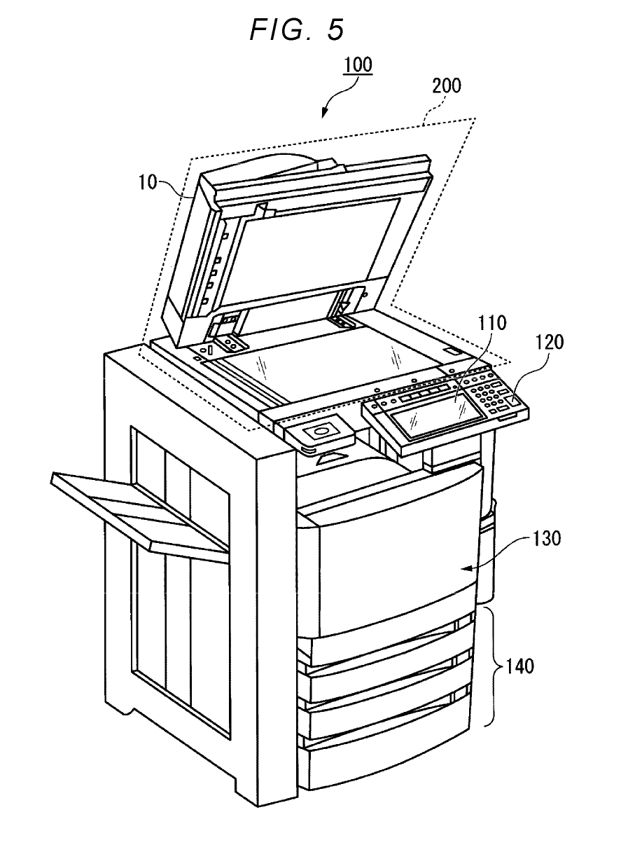

FIG. 5 is an external view of an image forming device 100 to which the sheet conveying device 10 of the present embodiment is applied. The image forming device 100 is, for example, a multi-function peripheral. The image forming device 100 includes a display 110, a control panel 120, a printer unit 130, a sheet storage unit 140, and an image reading device 200.

The image forming device 100 forms an image on a sheet by using a developer such as a toner. The display 110 is an image display device such as a liquid crystal display, an organic electro luminescence (EL) display, or the like. The display 110 displays various information on the image forming device 100.

The control panel 120 has a plurality of buttons. The control panel 120 receives a user's operation. The control panel 120 receives an operation for selecting an operation mode of the sheet conveying device 10, for example. The control panel 120 outputs a signal corresponding to the operation performed by the user to the control unit of the image forming device 100 or the image reading device 200. The display 110 and the control panel 120 may be an integral touch panel.

The printer unit 130 forms an image on the sheet based on the image information generated by the image reading device 200 or the image information received via a communication path. The printer unit 130 forms an image by the following processing, for example. The image forming unit of the printer unit 130 forms an electrostatic latent image on a photosensitive drum based on the image information. The image forming unit of the printer unit 130 forms a visible image by attaching the developer to the electrostatic latent image. A specific example of the developer is a toner. A transfer unit of the printer unit 130 transfers the visible image onto the sheet. A fixing unit of the printer unit 130 fixes the visible image on the sheet by heating and pressurizing the sheet. The sheet on which an image is to be formed may be stored in the sheet storage unit 140 or may be set by a hand.

The sheet storage unit 140 stores a sheet used for image formation in the printer unit 130.

The image reading device 200 reads the image information from the sheet conveyed by the sheet conveying device 10 as light and shade of light. The image reading device 200 records the read image information. The recorded image information may be transmitted to another information processing device via the network. The recorded image information may be formed on another sheet by the printer unit 130.

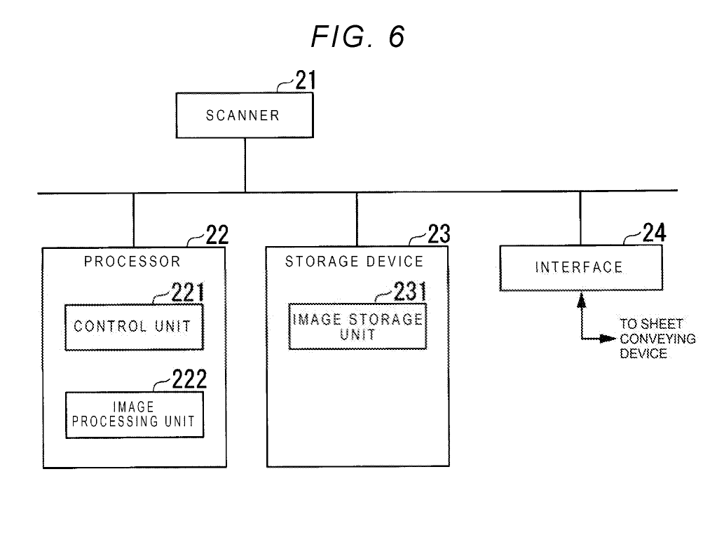

FIG. 6 is a functional block diagram of the image reading device 200. The image reading device 200 includes a scanner 21, a processor 22, a storage device 23, and an interface 24.

The scanner 21 includes an image sensor such as a charged-coupled device (CCD). The scanner 21 reads an image formed on the surface of the sheet conveyed by the sheet conveying device 10. The scanner 21 generates image data indicating the read image. The scanner 21 outputs the generated image data to the processor 22.

The processor 22 is a computing device such as a CPU and the like. The processor 22 functions as a control unit 221 and an image processing unit 222 by executing a predetermined program. The control unit 221 controls the operation of the scanner 21. For example, the control unit 221 controls the scanner 21 to read an image having a length corresponding to the determination result of the sheet length acquired via the interface 24. The image processing unit 222 executes predetermined image processing on the image data of the image read by the scanner 21. Specific examples of image processing executed by the image processing unit 222 include color correction processing, noise reduction processing, and the like.

The storage device 23 includes, for example, a magnetic hard disk device or a semiconductor storage device. The storage device 23 functions as an image storage unit 231. The image storage unit 231 stores image data of an image read by the scanner 21 and image data processed by the image processing unit 222.

The interface 24 transmits and receives signals between the image reading device 200 and another device. The interface 24 may transmit and receive signals to and from the sheet conveying device 10 connected to the image reading device 200, for example. For example, the interface 24 may receive a signal indicating the sheet length as determined by the sheet conveying device 10. For example, the interface 24 may transmit a signal indicating mode information entered by the user to the sheet conveying device 10 through the control panel 120.

In the image forming device 100 and the image reading device 200 described above, in the case of the first mode, image reading is executed according to the sheet length determined in accordance with the detection result of the length sensor. Therefore, if the sheet has a short sheet length, the image reading may be completed in a short time. On the other hand, in the second mode, image reading is executed according to the sheet length determined as a predetermined length (for example, the maximum length) regardless of the detection result of the length sensor. In this case, even if the length sensor incorrectly detects a sheet length as the shortest length detectable by the length sensor, image processing is executed with a sheet length longer than the detected length. As a result, in the image reading, it is possible to prevent lack of the image caused by terminating the processing without actually reading the existing image.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet conveying device comprising:
a length sensor configured to detect a length of a sheet to be conveyed; and
a processor configured to determine the length of the sheet while operating in a first mode and while operating in a second mode, wherein
while operating in the first mode, the processor determines the length detected by the length sensor as the length of the sheet, and
while operating in the second mode, the processor determines a predefined length as the length of the sheet, wherein the predefined length is greater than a shortest length detectable by the length sensor.

2. The device according to claim 1, further comprising:
a width sensor configured to detect a width of the sheet,
wherein the predefined length is equal to a maximum length corresponding to the width detected by the width sensor.

3. The device according to claim 1,
wherein the first mode is a mode selected by the user when a plurality of sheets having different sizes are to be conveyed and the second mode is a mode selected by a user when a plurality of substantially uniformly-sized sheets are to be conveyed.

4. The device according to claim 1, wherein the length sensor includes a plurality of sensors arranged in a sheet conveying direction.

5. The device according to claim 4, wherein the plurality of sensors includes a first sensor configured to detect a sheet having at least a first length, and a second sensor configured to detect a sheet having at least a second length that is greater than the first length.

6. The device according to claim 5, further comprising:
a surface on which the sheet is placed,
wherein each of the first and second sensors includes a lever that is elastically biased upward so that a portion of the lever protrudes upwards from the surface when no sheet is placed above the lever and is pressed downward to trigger a signal when a sheet is placed above the lever.

7. An image reading device comprising:
a length sensor configured to detect a length of a sheet to be conveyed;
a processor configured to determine the length of the sheet while operating in a first mode and while operating in a second mode, wherein while operating in the first mode, the processor determines the length detected by the length sensor as the length of the sheet, and while operating in the second mode, the processor determines a predefined length as the length of the sheet, wherein the predefined length is greater than a shortest length detectable by the length sensor; and
a scanner configured to read an image of the sheet according to the length determined by the processor.

8. The device according to claim 7,
wherein the scanner is configured to read the image from a leading edge of the sheet in a sheet conveying direction up to the length determined by the processor.

9. The device according to claim 8, further comprising:
a width sensor configured to detect a width of the sheet,
wherein the predefined length is equal to a maximum length corresponding to the width detected by the width sensor.

10. The device according to claim 8,
wherein the first mode is a mode selected by the user when a plurality of sheets having different sizes are to be conveyed and the second mode is a mode selected by a user when a plurality of substantially uniformly-sized sheets are to be conveyed.

11. The device according to claim 8, wherein the length sensor includes a plurality of sensors arranged in a sheet conveying direction.

12. The device according to claim 11, wherein the plurality of sensors includes a first sensor configured to detect a sheet having at least a first length, and a second sensor configured to detect a sheet having least a second length that is greater than the first length.

13. The device according to claim 12, further comprising:
a surface on which the sheet is placed,
wherein each of the first and second sensors includes a lever that is elastically biased upward so that a portion of the lever protrudes upwards from the surface when no sheet is placed above the lever and is pressed downward to trigger a signal when a sheet is placed above the lever.

14. An image reading method, comprising:
detect a length of a sheet to be conveyed using a length sensor;
determining a length detection mode;
upon determining that the length detection mode is a first mode, determining the length detected by the length sensor as the length of the sheet;
upon determining that the length detection mode is a second mode, determining a predefined length as the length of the sheet, wherein the predefined length is greater than a shortest length detectable by the length sensor; and
reading an image of the sheet according to the determined length.

15. The method according to claim 14,
wherein the image is read from a leading edge of the sheet in a sheet conveying direction up to the determined length.

16. The method according to claim 14, further comprising:
detecting a width of the sheet using a width sensor,
wherein the predefined length is equal to a maximum length corresponding to the width detected by the width sensor.

17. The method according to claim 14,
wherein the first mode is a mode selected by the user when a plurality of sheets having different sizes are to be conveyed and the second mode is a mode selected by a user when a plurality of substantially uniformly-sized sheets are to be conveyed.

18. The method according to claim 14, wherein the length sensor includes a plurality of sensors arranged in a sheet conveying direction.

19. The method according to claim 18, wherein the plurality of sensors includes a first sensor configured to detect a sheet having at least a first length, and a second sensor configured to detect a sheet having at least a second length that is greater than the first length.

20. The method according to claim 19, wherein
the sheet is placed on a surface of a sheet tray, and
each of the first and second sensors includes a lever that is elastically biased upward so that a portion of the lever protrudes upwards from the surface when no sheet is placed above the lever and is pressed downward to trigger a signal when a sheet is placed above the lever.
